(19) United States
(12) Patent Application Publication
(10) Pub. No.: US 2024/0046681 A1
(43) Pub. Date: Feb. 8, 2024

(54) IMAGE PROCESSING APPARATUS, CONTROL METHOD THEREOF, AND STORAGE MEDIUM

(71) Applicant: CANON KABUSHIKI KAISHA, Tokyo (JP)

(72) Inventor: HIROSHI SEKINE, Chiba (JP)

(21) Appl. No.: 18/365,761

(22) Filed: Aug. 4, 2023

(30) Foreign Application Priority Data
Aug. 8, 2022 (JP) 2022-126608

(51) Int. Cl. G06V 30/22; G06V 30/19

(52) U.S. Cl. CPC G06V 30/22; G06V 30/19147

(57) ABSTRACT

An image processing apparatus obtains image data generated by reading a sheet on which handwritten characters are written. The image processing apparatus selects a trained model to be used for character recognitions of the handwritten characters on the sheet from a plurality of trained models and executes character recognitions by using the selected trained model.

### BACKGROUND

### Field of the Disclosure

The present disclosure relates to an image processing apparatus that performs handwritten character recognition using machine learning, a control method thereof, and a storage medium.

### Description of the Related Art

Japanese Patent Laid-Open No. 2022-61192 proposes a technique for analyzing image data by selecting a plurality of trained models having a hierarchical relationship from a plurality of trained models.

In handwritten character recognition, each person has their own idiosyncrasies when writing. Therefore, a word recognition rate or a character recognition rate can be further increased if individually trained models can be used in accordance with the idiosyncrasies of the handwritten characters and the features of the handwritten characters for each user instead of a common trained model.

### SUMMARY

The present disclosure enables realization of a mechanism for suitably selecting a trained model to be used for handwritten character recognition from a plurality of trained models.

One aspect of the present disclosure provides an image processing apparatus comprising: at least one memory device that stores a set of instructions; and at least one processor that executes the set of instructions to obtain image data generated by reading a sheet on which a handwritten character is written; select a trained model to be used for character recognition of the handwritten character on the sheet from a plurality of trained models; and execute character recognition by using the selected trained model.

Another aspect of the present disclosure provides a method of controlling an image processing apparatus, the method comprising: obtaining image data generated by reading a sheet on which a handwritten character is written; selecting a trained model to be used for character recognition of the handwritten character on the sheet from a plurality of trained models; and executing character recognition by using the selected trained model.

Still another aspect of the present disclosure provides a non-transitory computer-readable storage medium storing program for causing a computer to execute each step of a method for controlling an image processing apparatus, the method comprising: obtaining image data generated by reading a sheet on which a handwritten character is written; selecting a trained model to be used for character recognition of the handwritten character on the sheet from a plurality of trained models; and executing character recognition by using the selected trained model.

Further features of the present disclosure will be apparent from the following description of exemplary embodiments with reference to the attached drawings.

### BRIEF DESCRIPTION OF THE DRAWINGS

FIG. 1 is a diagram illustrating an example of a configuration of a system according to one or more aspects of the present disclosure.

FIG. 2A is a diagram illustrating an example of a configuration of an image processing apparatus according to one or more aspects of the present disclosure.

FIG. 2B is a diagram illustrating an example of a configuration of a training server according to one or more aspects of the present disclosure.

FIG. 3 is a diagram illustrating an example of supervised data according to one or more aspects of the present disclosure.

FIG. 4 is a diagram illustrating an operation of the training server according to one or more aspects of the present disclosure.

FIG. 5A to FIG. 5D are diagrams illustrating a procedure for installing a trained model according to one or more aspects of the present disclosure.

FIG. 6A and FIG. 6B are diagrams illustrating an example of a procedure for setting a link between a logged-in user and a trained model according to one or more aspects of the present disclosure.

FIG. 7 illustrates an example of a log-in screen according to one or more aspects of the present disclosure.

FIG. 8 is a diagram illustrating a data sequence in an inference phase according to one or more aspects of the present disclosure.

FIG. 9 is a diagram illustrating an example of input data and output data according to one or more aspects of the present disclosure.

FIG. 10 is a flowchart illustrating a processing procedure for linking a logged-in user with a trained model according to one or more aspects of the present disclosure.

FIG. 11 is a diagram illustrating a UI flow for selecting an arbitrary trained model according to one or more aspects of the present disclosure.

FIG. 12 is a flowchart illustrating a processing procedure for selecting an arbitrary trained model according to one or more aspects of the present disclosure.

FIG. 13 illustrates a UI flow for a setting linking a language setting and a trained model according to one or more aspects of the present disclosure.

FIG. 14 is a flowchart illustrating a processing procedure for a setting linking a language setting and a trained model according to one or more aspects of the present disclosure.

FIG. 15 is a diagram illustrating an example of input data and output data according to one or more aspects of the present disclosure.

FIG. 16 is a diagram illustrating a data sequence in an inference phase according to one or more aspects of the present disclosure.

FIG. 17 is a flowchart illustrating a processing procedure for linking a trained model according to one or more aspects of the present disclosure.

FIG. 18 is a diagram illustrating a data sequence in an inference phase according to one or more aspects of the present disclosure.

FIG. 19 is a flowchart illustrating a processing procedure for linking a trained model according to one or more aspects of the present disclosure.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

### First Embodiment

### System Configuration

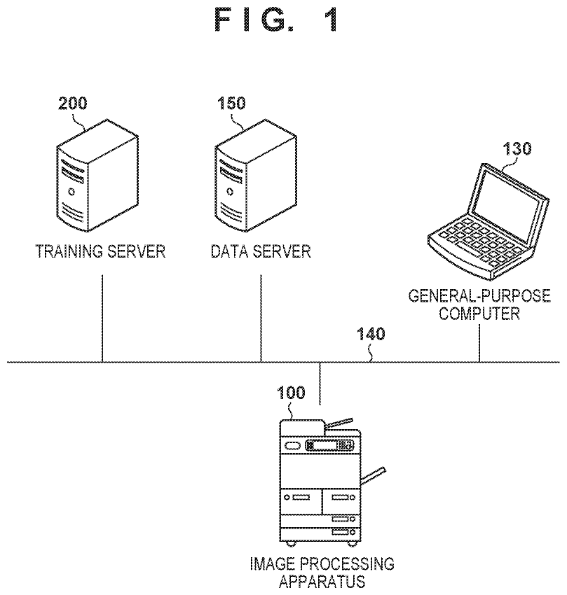

Hereinafter, an embodiment of the present disclosure will be described with reference to the drawings. First, the overall configuration of a system according to the present embodiment will be described with reference to FIG. 1.

The system is configured to include an image processing apparatus 100, a training server 200, a general-purpose computer 130, and a data server 150. These devices are connected via a LAN 140 such as a wired LAN, and can transmit and receive data to and from each other. The image processing apparatus 100 is an apparatus having an image processing function such as a printer, a multifunction peripheral, a FAX, or a scanner. The image processing apparatus 100 may or may not include a reading unit such as a scanner. In a case where a reading unit is not provided, handwritten character recognition, which will be described later, is performed using image data read from a sheet or the like by another apparatus. In the present embodiment, a multifunction peripheral (MFP) is described using the example of an image processing apparatus.

The general-purpose computer 130 transmits print data to the image processing apparatus 100. The data server 150 collects training data used for machine learning in the training server 200 from an external device and provides the collected training data to the training server 200. The training server 200 generates a model using image data read from handwritten character sheets (documents) or the like externally provided as supervisory data, and provides the generated model to the image processing apparatus 100. Note that the types and numbers of these apparatuses are merely examples, and are not intended to limit the present disclosure. For example, multiple apparatuses may be integrally provided, or the disclosure may be realized by distributing functions across more apparatuses. More specifically, the image processing apparatus 100 may be configured to have at least one function of the training server 200 and the data server 150. Alternatively, the training server 200 may be configured to have at least one of a function other than the reading function of the image processing apparatus 100 and a function of the data server 150.

### Image Processing Apparatus Configuration

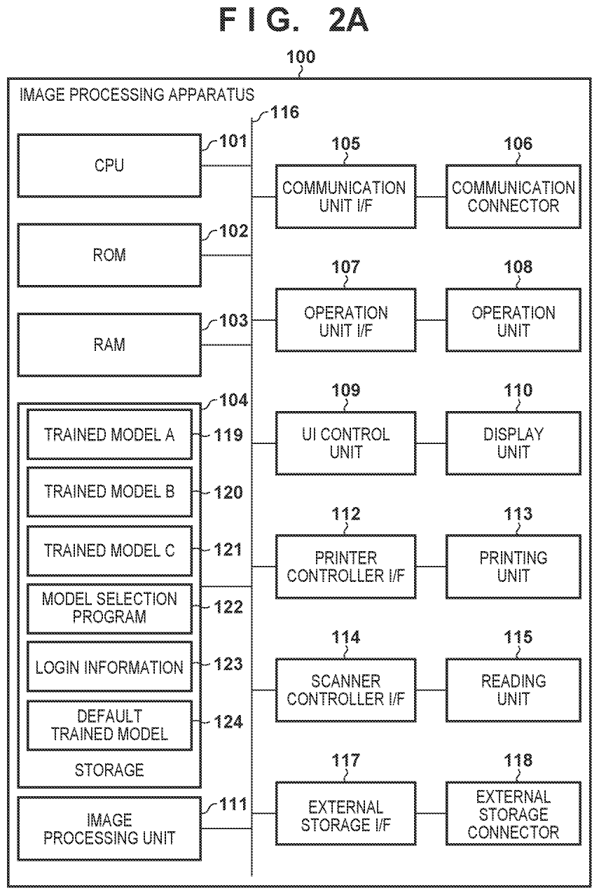

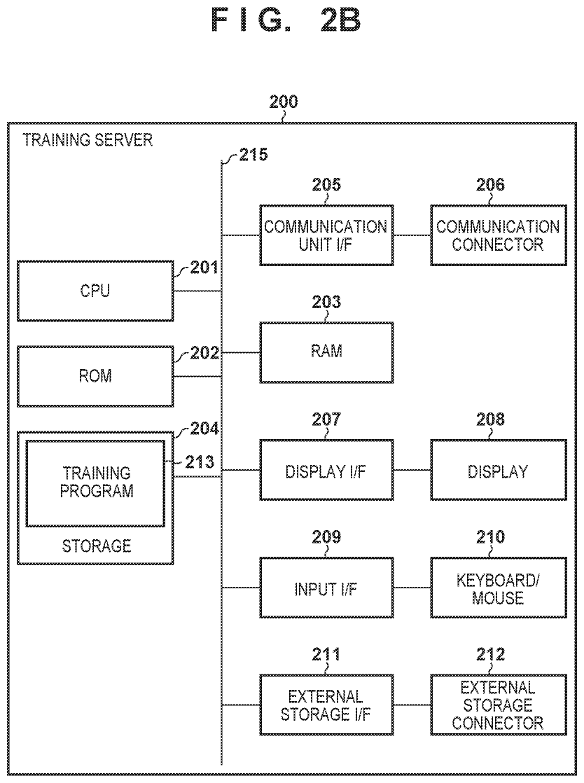

Next, an example of a configuration of the image processing apparatus 100 according to the present embodiment will be described with reference to FIG. 2A. The image processing apparatus 100 includes a CPU 101, a ROM 102, a RAM 103, a storage 104, a communication unit I/F 105, and an operation unit I/F 107. The image processing apparatus 100 includes a UI control unit 109, a printer controller I/F 112, a scanner controller I/F 114, and an external storage I/F 117. The image processing apparatus 100 further includes a communication connector 106, an operation unit 108, a display unit 110, a printing unit 113, a reading unit 115, and an external storage connector 118. The modules are connected to each other via a system bus 116 so as to be able to transmit and receive data.

The CPU 101 controls overall operation of the image processing apparatus 100. The CPU 101 reads a control program stored in the ROM 102 or the storage 104, and performs various controls such as reading control and print control. The ROM 102 stores a control program that can be executed by the CPU 101, and stores a boot program that is executed at startup. The RAM 103 is a main storage memory of the CPU 101 and is used as a work area and as a temporary storage region for loading various control programs stored in the ROM 102 and the storage 104. The storage 104 stores print data, image data, various programs, various setting information, and the like. In addition, some processes may be executed by using hardware circuitry such as an Application Specific Integrated Circuit (ASIC) or a Field-Programmable Gate Array (FPGA).

The operation unit I/F 107 is connected to the operation unit 108 and receives user operations performed on the operation unit 108. The scanner controller I/F 114 is connected to the reading unit 115 and obtains the image data read from a scanned sheet. The reading unit 115 reads an image on the sheet to generate image data. The image data generated by the reading unit 115 is transmitted to an external device such as the training server 200, the data server 150, or the general-purpose computer 130, or is used to print an image onto a sheet. In addition, the read image data is used as an input for OCR. OCR is an abbreviation for Optical Character Recognition.

The printer controller I/F 112 is connected to the printing unit 113 and controls data exchange with the printing unit 113. Image data to be printed is transferred to the printing unit 113 via the printer controller I/F 112. The printing unit 113 receives a control command and image data to be printed, and prints an image based on the image data on a sheet. The printing method of the printing unit 113 may be an electrophotographic method or an inkjet method.

The communication unit I/F 105 is connected to the communication connector 106, and connects the image processing apparatus 100 to a network (not illustrated) via the communication connector 106 to control communication with an external device. The UI control unit 109 is connected to the display unit 110, which may be an LCD or the like, and performs display control of the display unit 110. An image processing unit 111 rotates, compresses, and converts the resolution of image data outputted to the printing unit 113 via the printer controller I/F 112. The external storage I/F 117 is connected to the external storage connector 118 and writes or reads data to or from an external storage such as a USB memory.

In the present embodiment, the storage 104 holds a plurality of models such as a trained model A 119, a trained model B 120, a trained model C 121, and a default trained model 124, which are models trained according to a machine learning method. The storage 104 also stores a model selection program 122 that selects a model to be used in the inference phase among the trained models. In the storage 104, information for logging into the image processing apparatus 100, such as login information 123, is stored. These trained models are obtained from an external device such as the training server 200, which can communicate via the communication connector 106, a network storage, or the like, or an external storage such as a USB memory that can be connected via the external storage connector 118.

### Training Server Configuration

Next, an example of a configuration of the training server 200 according to the present embodiment will be described with reference to FIG. 2B. The training server 200 includes a CPU 201, a ROM 202, a RAM 203, a storage 204, a communication unit I/F 205, a display I/F 207, an input I/F 209, and an external storage I/F 211. Further, the training server 200 includes a communication connector 206, a display 208, a keyboard/mouse 210, and an external storage connector 212. The modules are connected to each other via a system bus 215 so as to be able to transmit and receive data.

The training server 200 is what is generally referred to as a personal computer, and the CPU 201 provided therein controls the training server 200 overall. The CPU 201 directly reads and executes programs stored in the ROM 202 and the storage 204, or reads and executes programs after loading them into the RAM 203. The communication unit I/F 205, under control by the CPU 201, transmits data generated by the CPU 201 to, for example, the image processing apparatus 100, which is connected to a network (not illustrated), via the communication connector 206. The communication unit I/F 205 performs control for transmitting and receiving data to and from the image processing apparatus 100.

The display 208 is an output apparatus for performing display for a user, and is connected via the display I/F 207. The keyboard/mouse 210 is an input apparatus that accepts operations from a user and is connected via the input I/F 209. The user can operate the training server 200 using the keyboard/mouse 210 while confirming the display on the display 208. The external storage connector 212 connects an external storage such as a USB memory (not illustrated) and writes or reads data to or from a connected storage. The external storage connector 212 is connected via the external storage I/F 211.

The storage 204 stores a training program 213, and in the present embodiment, the training program 213 is activated by a user operation, and operated to output the trained model A 119, the trained model B 120, the trained model C 121, and the like. The outputted trained model A 119, trained model B 120, and trained model C 121 are stored in an external storage and installed in the image processing apparatus 100.

### Supervised Data

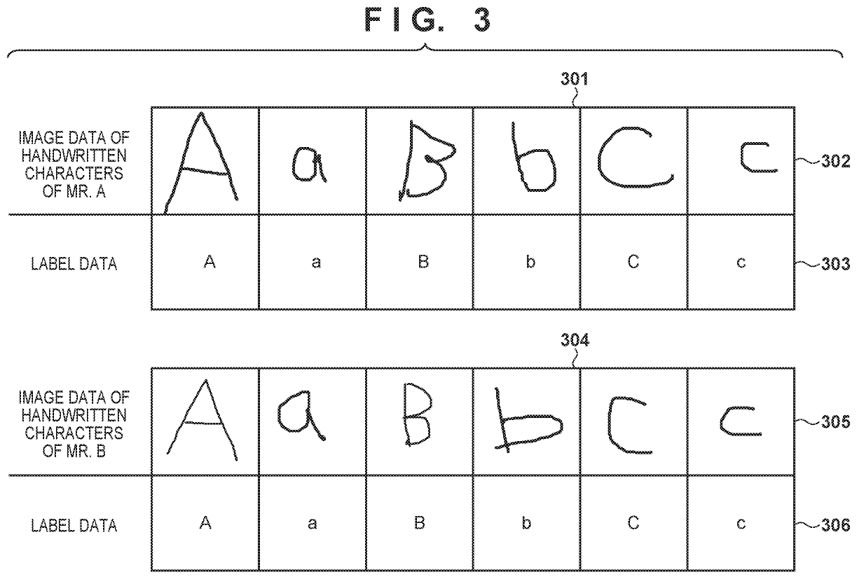

Next, an example of supervised data for training according to the present embodiment will be described with reference to FIG. 3. The training program 213 includes a program that causes the training server 200 to read training data 301 in order to output the trained model A 119. Image data 302 is characters handwritten by Mr. A, and is read by the reading unit 115 of the image processing apparatus 100 after the handwritten characters are written on a sheet, and image data thereof is obtained. Label data 303 is ground truth data (supervisory data) corresponding to the image data 302 of the handwritten character of Mr. A. The training program 213 outputs the trained model A 119 from the training data 301.

The training program 213 similarly includes a program that causes the training server 200 to read training data 304 in order to output the trained model B 120. Image data 305 is characters handwritten by Mr. B, and label data 306 is ground truth data of the image data 305. The training program 213 outputs the trained model B 120 from the training data 304. Note that this training data is merely an example and is not intended to limit the present disclosure, and other known training data may be used.

### Training Server Operation

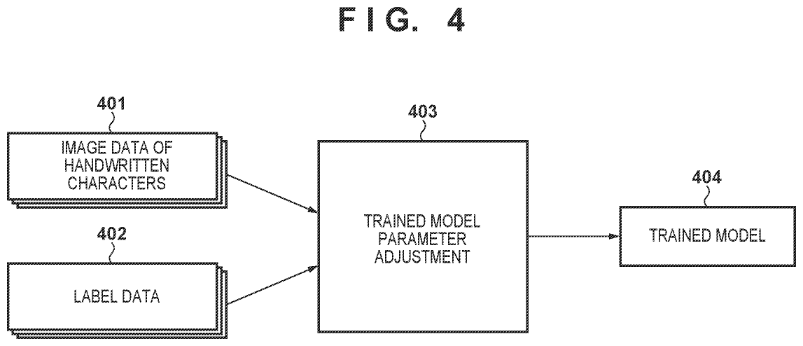

Next, an example of operation when the training server 200 executes the training program 213 will be described with reference to FIG. 4. The operations described below are realized by the CPU 201 reading the training program 213 from the storage 204 into the RAM 203 and executing the training program 213.

When the CPU 201 executes the training program 213, the CPU 201 reads data and ground truth data thereof, and generates a trained model for outputting optimal inference results. The handwritten character image data 401 is a plurality of pieces of image data, and corresponds to the image data 302 and the image data 305 in FIG. 3. Label data 402 is ground truth data (supervisory data) corresponding to the image data 401, and corresponds to the label data 303 and the label data 306 in FIG. 3.

In a block 403, parameters of the trained model are adjusted, and a trained model 404 is outputted by learning the image data 401 and the label data 402 which is ground truth data thereof as inputs. For example, in a case where the input to the block 403 is the training data 301, the trained model A 119 is outputted, and in a case where the input is the training data 304, the trained model B 120 is outputted. Note that the learning method of the present disclosure is not intended to be limited to the above-described method, and any known learning method for outputting a trained model may be applied.

### Screen Examples

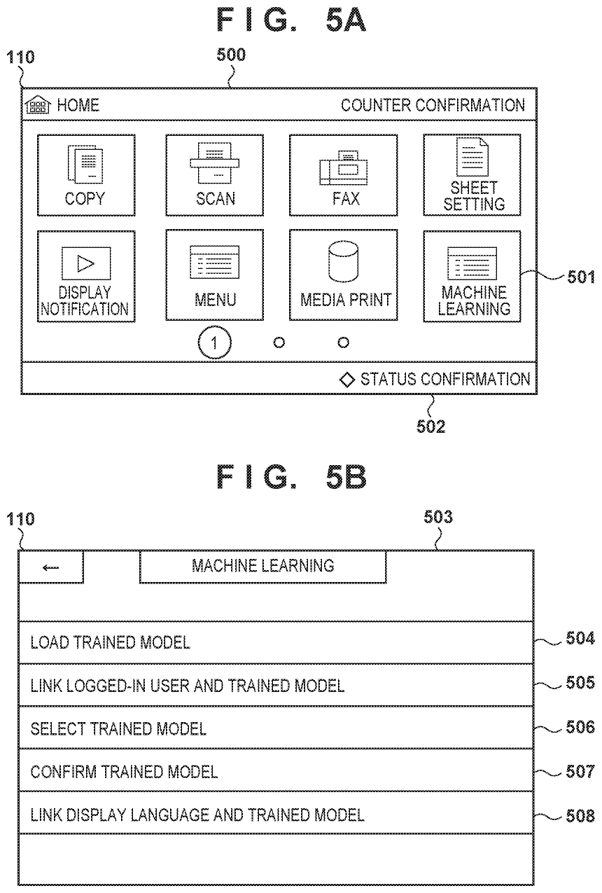

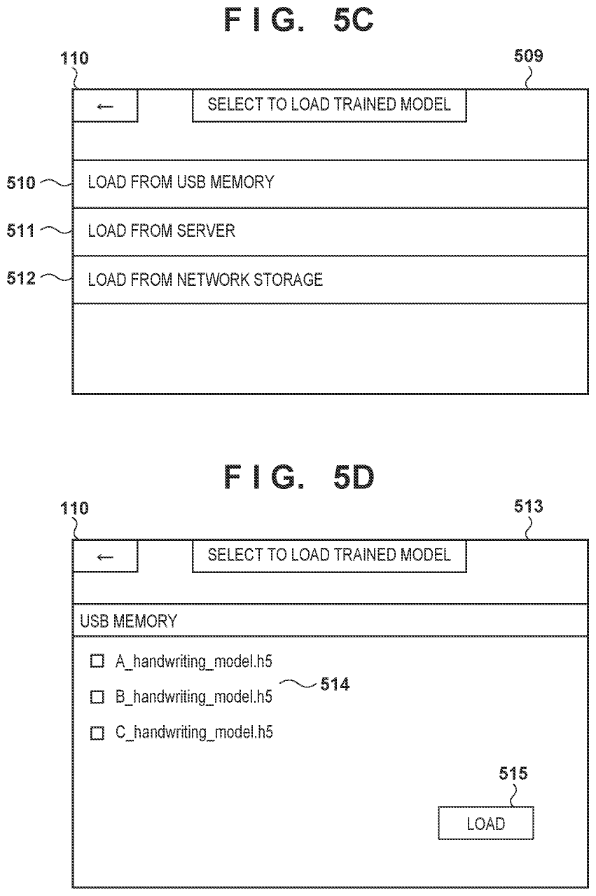

Hereinafter, an example of screens displayed on the display unit 110 of the image processing apparatus 100 will be described with reference to FIG. 5A to FIG. 7. Here, an example of screens displayed when each operation is performed and screen transitions will be described.

### Trained Model Installation Procedure

FIGS. 5A to 5D illustrate a UI flow of the image processing apparatus 100 when the trained model 404 generated by the training server 200 is installed in the image processing apparatus 100. The user stores the trained model 404 outputted by the training server 200 in an external storage such as a USB memory (not illustrated) via the external storage connector 212. Further, the USB memory is connected by insertion into the external storage connector 118 of the image processing apparatus 100.

FIG. 5A illustrates an example of a home screen 500 displayed on the display unit 110 of the image processing apparatus 100. When a machine learning icon 501 of the home screen 500 is pressed, operation information is transmitted from the operation unit 108, which is a touch panel, to the CPU 101 via the operation unit I/F 107, and the CPU 101 operates to display a machine learning screen 503 illustrated in FIG. 5B. A status display region 502 on the home screen 500 is a region for displaying the currently set trained model, and details thereof will be described later.

The machine learning screen 503, which is an example of a selection menu, is configured to include buttons 504 to 508. The button 504 is a button for loading a trained model. The button 505 is a button for linking a logged-in user and a trained model. The button 506 is a button for selecting a trained model. The button 507 is a button for confirming a trained model. The button 508 is a button for linking a display language and a trained model.

When the button 504 is pressed, a transition is made to a screen 509 for loading the trained model of FIG. 5C. Operations when the buttons 505, 507, and 508 are pressed will be described later. On the screen 509, a menu indicating the source of the trained model to be loaded is illustrated, and for example, buttons 510 to 512 are displayed so as to be selectable. The button 510 is a button for loading a trained model from a USB memory. The button 511 is a button for loading a trained model from a server. The button 512 is a button for loading a trained model from a network storage. For example, when the button 510 is pressed, as illustrated in FIG. 5D, a transition is made to a list screen 513 of selectable trained models. In the list screen 513, a list 514 of trained models that can be loaded from the USB memory is displayed. When the user selects a trained model and presses a load button 515, the target trained model is stored in the storage 104 of the image processing apparatus 100.

### Procedure for Linking User and Trained Model

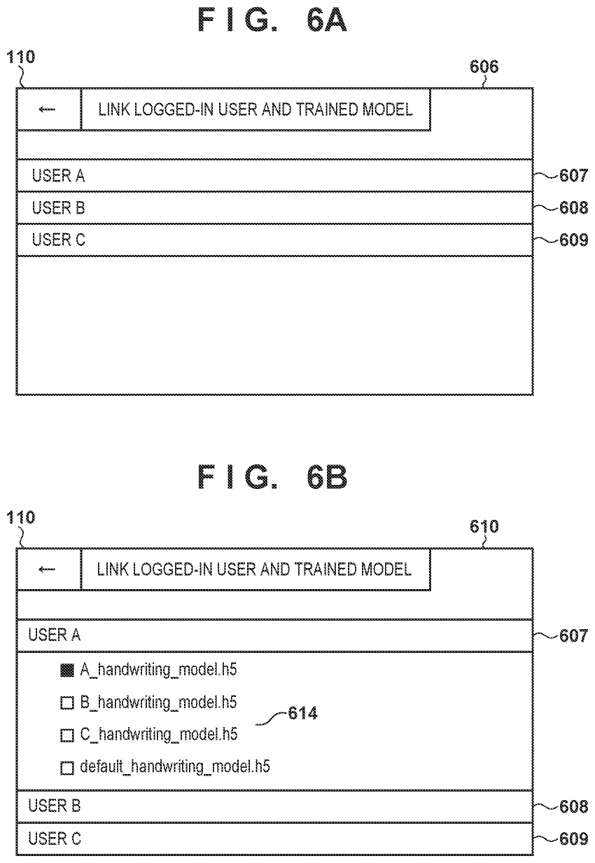

FIGS. 6A and 6B illustrates a UI flow for when a link between a logged-in user and a trained model is set. Here, a screen transition when an appropriate trained model is set in accordance with a user operation in a case where characters handwritten by a logged-in user are identified will be described. Although an example in which a logged-in user and a trained model are linked with each other will be described below, the present disclosure is not intended to be limited thereto. For example, characters handwritten by a user other than the logged-in user may be recognized, and in such a case, the user corresponding to the handwritten characters and the trained model may be linked with each other instead of the logged-in user. That is, the present disclosure is not limited to the case where the user who has written the handwritten characters is the logged-in user.

FIG. 6A illustrates a selection screen 606 for selecting a logged-in user that transitions when the button 505 that links a logged-in user with a trained model is pressed from the machine learning screen 503 of FIG. 5B. In the selection screen 606, users who can log in to the image processing apparatus 100 are displayed, and because a user A, a user B, and a user C are selectable in the present embodiment, buttons 607, 608, and 609 by which it is possible to select the respective users are displayed.

FIG. 6B illustrates a setting screen 610 that is displayed when the button 607 corresponding to the user A is pressed and that links the logged-in user and the trained model. On the setting screen 610, one or more trained models 614 that can be linked with the user A are displayed. By selecting a trained model from among these, it is possible to link the trained model to be used with the logged-in user. FIG. 6B illustrates an example in which the trained model “A_handwriting_model.h5” is selected, and the model trained on characters handwritten by the user A is selected. The selected trained model is displayed in the status display region 502 on the home screen 500. Here, an example in which the name or the file name of the trained models is displayed is illustrated, but configuration may be taken so as to separately display whether it is a trained model specific to the user. This eliminates the need for the user to recognize in advance which trained model is applicable to the user.

### Log-In Screen

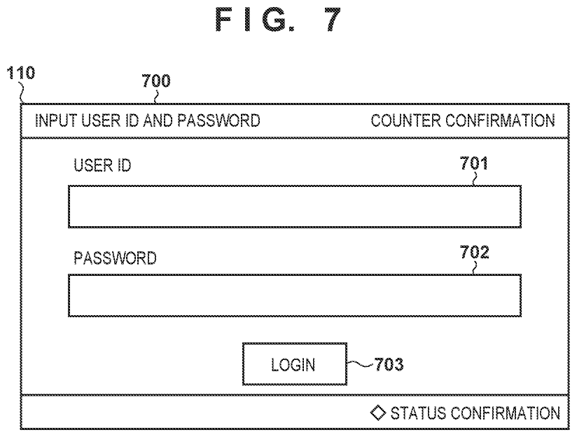

FIG. 7 illustrates an example of a log-in screen 700 displayed on the display unit 110 of the image processing apparatus 100. The log-in screen 700 is configured to include a user ID input field 701 and a password input field 702.

In the user ID input field 701, a user ID for identifying the user is inputted via a physical keyboard, a virtual keyboard, or the like (not illustrated). In the password input field 702, a password linked with the user ID is inputted. When the login button 703 is pressed in a state in which the user ID and the password are inputted, the CPU 101 compares the inputted user ID and password with a user ID and password stored in advance in the storage 104 of the image processing apparatus 100. The CPU 101 then allows the user to log in if the result of the comparison is a match. The login method is not limited to the present embodiment, and any known login method may be applied.

### Inference Phase Data Flow

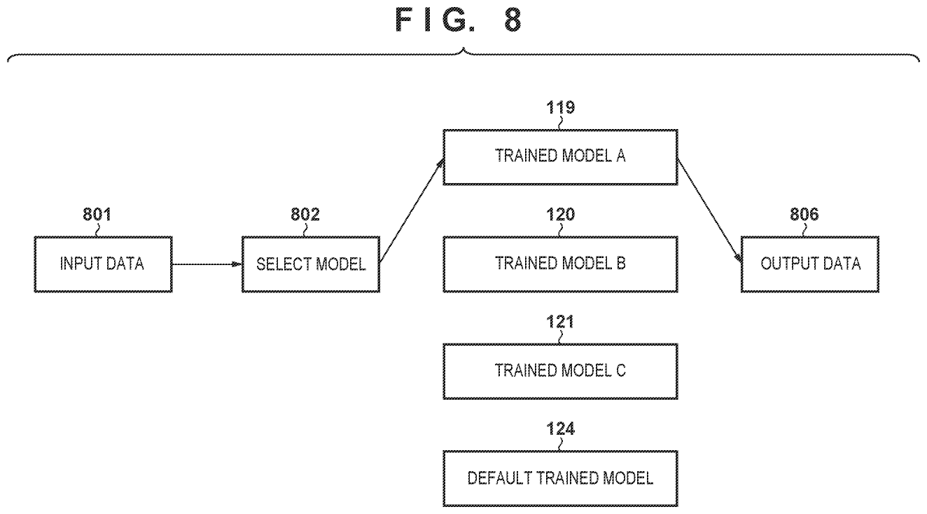

Next, a data flow in an inference phase according to the present embodiment will be described with reference to FIG. 8. In the inference phase according to the present embodiment, data is inputted to a trained model generated by executing the training program 213, and a handwritten character recognition result is obtained as an output corresponding to the input data. The output includes a character string recognized from handwritten characters.

A block 802 indicates a functional module generated by executing the model selection program. When input data 801 is inputted to the block 802, the functional module links the logged-in user with the trained model to select which trained model to use from the plurality of trained models. In the example of FIG. 8, since the logged-in user is the user A, the trained model A119 is selected, and the input data 801 is inputted to the trained model A119. The trained model A119 outputs output data 806 corresponding to the input data 801.

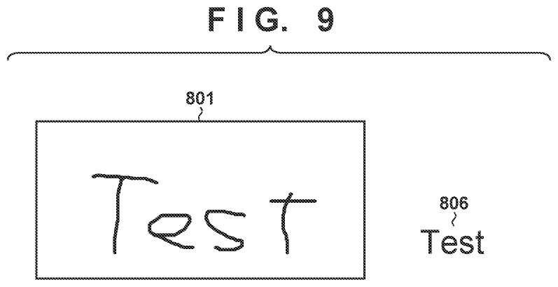

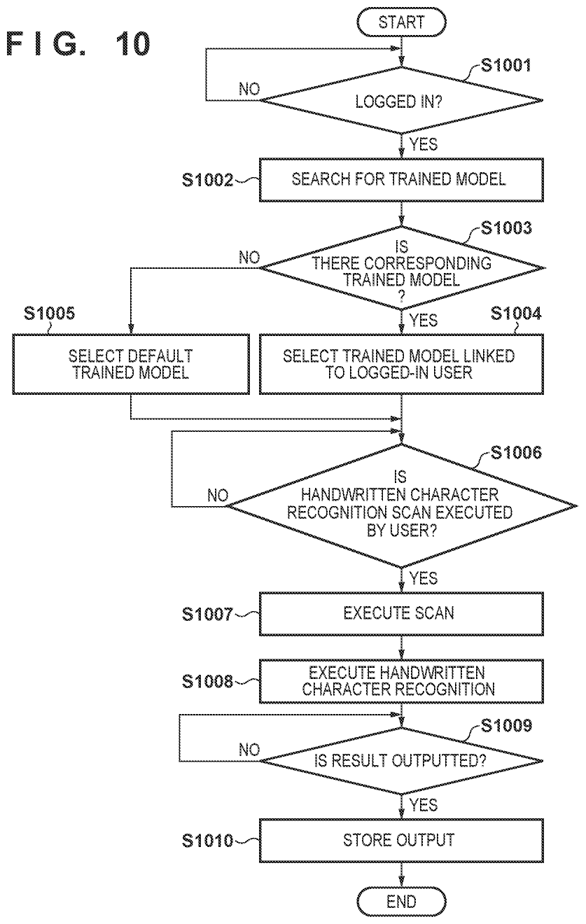

FIG. 9 illustrates an example of the input data 801 and the output data 806. The input data 801 is obtained by converting an image obtained by reading handwritten characters on a sheet by using the reading unit 115 of the image processing apparatus 100 into data. The output data 806 is text data (an inference result) obtained as the output when inputting the input data 801, which is image data, into the trained model A 119.

### Processing Procedure

Next, a processing procedure of the image processing apparatus 100 that links the logged-in user and the trained model according to the present embodiment will be described with reference to FIG. 10. Here, a process of selecting a trained model according to a setting that links a predetermined user and a corresponding trained model described with reference to FIG. 6 when the user logs in will be described. The process described below is realized by, for example, the CPU 101 reading a program (for example, the model selection program 122) stored in advance in the storage 104 into the RAM 103 and executing the program.

In step S1001, the CPU 101 waits until a predetermined user is logged into the image processing apparatus 100. Once the user has logged in, the CPU 101 proceeds to step S1002 and searches for a trained model linked with the logged-in user. Next, in step S1003, the CPU 101 determines whether a trained model linked with the user who logged in in step S1002 was found. If a trained model was found, the CPU 101 proceeds to step S1004; otherwise the CPU 101 proceeds to step S1005.

In step S1004, the CPU 101 selects a trained model linked with the logged-in user, sets the model to be used for recognizing handwritten characters, and proceeds to step S1006. On the other hand, in step S1005, if a trained model linked with the logged-in user is not found, the CPU 101 selects the default trained model 124, sets the default trained model 124 to be used for recognizing handwritten characters, and proceeds to step S1006.

In step S1006, the CPU 101 waits until the user performs a handwritten character recognition scan, and proceeds to step S1007 when a handwritten character recognition scan is performed. In step S1007, the CPU 101 causes the reading unit 115 to scan a sheet on which handwritten characters are written, stores the outputted scanned image in the storage 104, and executes the model selection program 122 using the stored scanned image as the input data 801.

Next, in step S1008, the CPU 101 executes the model selection program 122 to perform handwritten character recognition using the trained model selected from the plurality of trained models in step S1004 or step S1005. Subsequently, in step S1009, the CPU 101 waits for the output of the handwritten character recognition from the model executed in step S1008, and proceeds to step S1010 when the handwritten character recognition result is outputted. In step S1010, the CPU 101 stores handwritten character recognition output data 806 in the storage 104, and ends the processing of this flowchart.

As described above, the image processing apparatus according to the present embodiment reads a sheet on which handwritten characters are written, and obtains outputted image data. Further, the image processing apparatus selects a trained model to be used for character recognition of handwritten characters on the sheet from a plurality of trained models based on the information on the handwritten characters of the sheet, and performs character recognition using the selected trained model. Further, the image processing apparatus selects a trained model linked with a logged-in user of the image processing apparatus from a plurality of trained models. As described above, according to the present embodiment, a trained model linked with a logged-in user is selected from a plurality of trained models and used for recognition of handwritten characters. Thus, according to the present embodiment, it is possible to suitably select a trained model to be used for handwritten character recognition from a plurality of trained models.

### Second Embodiment

Hereinafter, a second embodiment of the present disclosure will be described. In the present embodiment, a form in which a trained model corresponding to a user operation is selected from a plurality of trained models and used for recognition of handwritten characters will be described.

### Screen Example

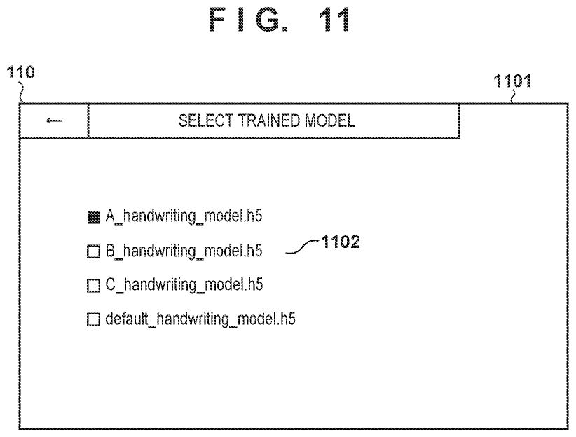

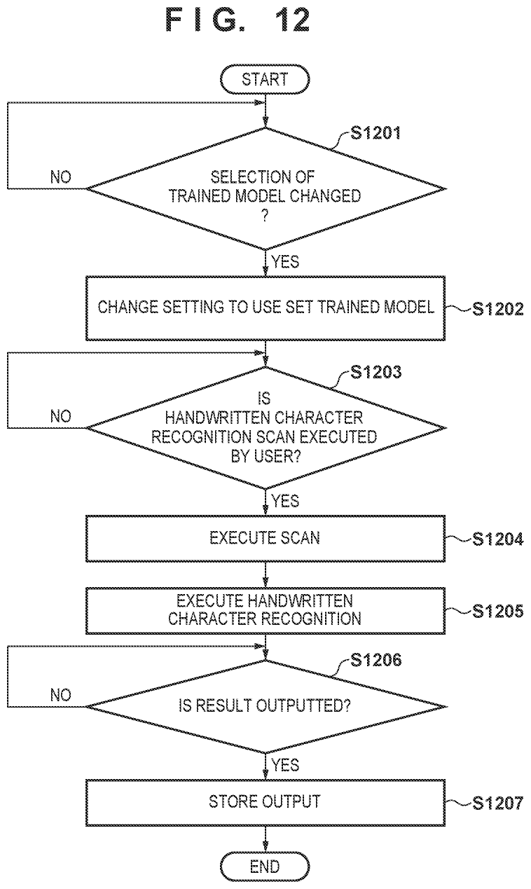

First, an example of a selection screen for selecting an arbitrary trained model in the present embodiment will be described with reference to FIG. 11. A selection screen 1101 is displayed on the display unit 110 of the image processing apparatus 100.

When the trained model selection button 506 is pressed on the machine learning screen 503 in FIG. 5B, the process transitions to the trained model selection screen 1101 illustrated in FIG. 11. In the selection screen 1101, the user can select any trained model from a list 1102 including the plurality of trained models. In the screen example of FIG. 11, a situation in which the trained model “A_handwriting_model.h5” is selected is illustrated. Further, the trained model that is currently set may be displayed in the status display region 502 on the home screen 500.

### Processing Procedure

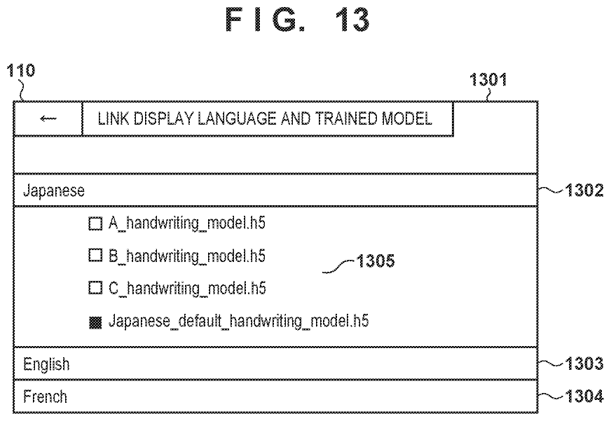

Next, a processing procedure of the image processing apparatus 100 for when an arbitrary trained model is selected by a user operation according to the present embodiment will be described with reference to FIG. 12. The process described below is realized by, for example, the CPU 101 reading a program (for example, the model selection program 122) stored in advance in the storage 104 into the RAM 103 and executing the program.

In step S1201, the CPU 101 determines whether the setting of the trained model has been changed by the user. Here, the CPU 101 waits until the setting is changed by the user, and proceeds to step S1202 when the setting is changed. In step S1202, the CPU 101 changes the setting to use the trained model set in the selection screen 1101. More specifically, the CPU 101 stores the setting change information in the storage 104. Here, for example, the CPU 101 may be realized by holding flag information or the like that can be identified as a trained model to be used, with a newly set trained model. When information indicating the change in setting of the selection of the trained model is stored in the storage 104, the processing proceeds to step S1203. The processes of step S1203 to step S1207 are the similar to the processes of step S1006 to step S1010 described with reference to FIG. 10, and description thereof will be omitted.

As described above, the image processing apparatus according to the present embodiment selects a trained model corresponding to a user operation from a plurality of trained models and uses the selected model for recognition of handwritten characters. Thus, according to the present embodiment, it is possible to suitably select a trained model to be used for handwritten character recognition from a plurality of trained models.

### Third Embodiment

Hereinafter, a third embodiment of the present disclosure will be described. In the present embodiment, a form will be described in which a trained model linked with a designated language such as Japanese, English, or French is selected from a plurality of trained models and used for recognition of handwritten characters.

### Screen Example

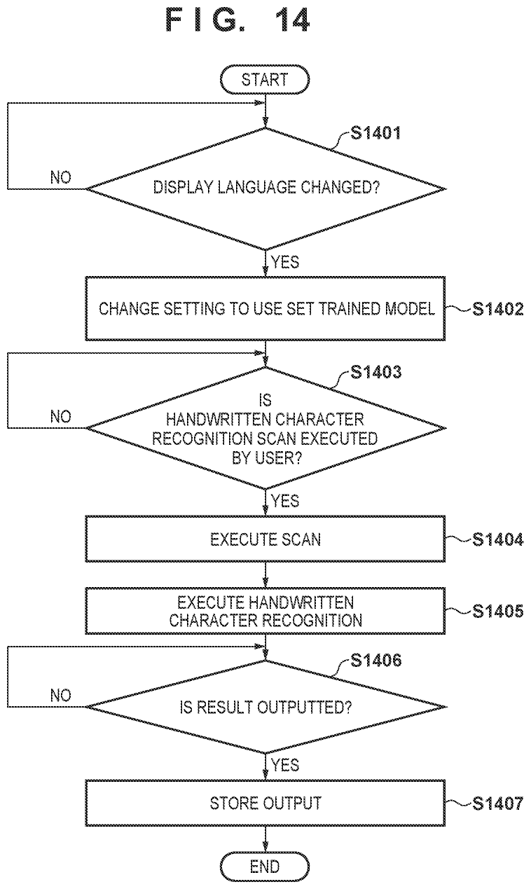

First, an example of a setting screen for performing a setting for linking a language setting and a trained model in the present embodiment will be described with reference to FIG. 13. A setting screen 1301 is displayed on the display unit 110 of the image processing apparatus 100.

When the button 508 for linking a display language with a trained model is pressed from the machine learning screen 503 of FIG. 5B, the display transitions to the setting screen 1301 for setting a link between the display language and the trained model, illustrated in FIG. 13. In the setting screen 1301, a plurality of language buttons are displayed so as to be able to be designated, and a desired trained model can be selected from a trained model list 1305 for the respective languages. In the present embodiment, a Japanese button 1302, an English button 1303, and a French button 1304 are selectably displayed. Further, when the Japanese button 1302 is pressed, the trained model list 1305 is displayed, and a desired trained model can be selected from the trained models by a user operation. Instead of being selected by a user operation, selection may be made based on a logged-in user similarly to the above-described first embodiment. In addition, in a case where there is no trained model linked with the logged-in user, a predetermined default trained model may be selected or selection may be in accordance with a user operation. Furthermore, a predetermined trained model may be selected based on the designated display language.

### Processing Procedure

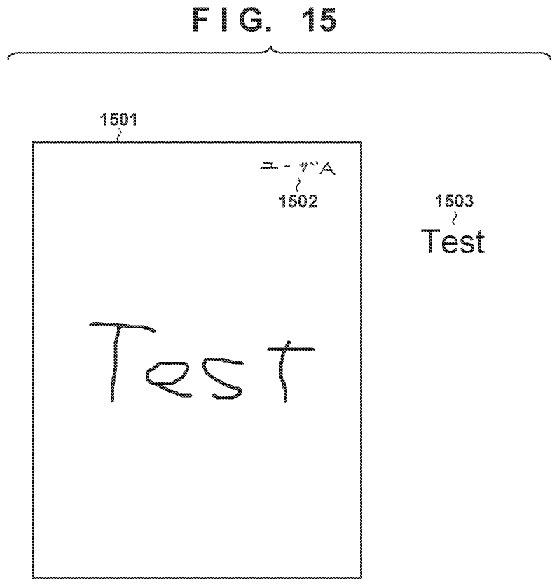

Next, a processing procedure of the image processing apparatus 100 that links a language setting and a trained model according to the present embodiment will be described with reference to FIG. 14. The process described below is realized by, for example, the CPU 101 reading a program (for example, the model selection program 122) stored in advance in the storage 104 into the RAM 103 and executing the program.

In step S1401, the CPU 101 determines whether the display language of the image processing apparatus 100 has been changed by the user. Here, the CPU 101 waits until the setting is changed by the user, and proceeds to step S1402 when the setting is changed. In step S1402, the CPU 101 changes the setting to use the trained model corresponding to the display language designated in the setting screen 1301. More specifically, the CPU 101 stores the setting change information in the storage 104. The storage method may be any method, similarly to step S1202 described above. As the setting of the trained model, for example, a plurality of trained models corresponding to the designated display language may be selectably displayed, and a predetermined trained model may be selected from the displayed candidates in accordance with a user operation. Alternatively, a trained model corresponding to a predetermined user, such as a logged-in user, may be selected from a plurality of trained models corresponding to a designated display language. When information related to a change in the setting is stored in the storage 104, the processing proceeds to step S1403. The processes of step S1403 to step S1407 are similar to the processes of step S1006 to step S1010 described with reference to FIG. 10, and description thereof will be omitted.

As described above, the image processing apparatus according to the present embodiment selects a trained model linked with a target language such as Japanese, English, or French from a plurality of trained models and uses the selected trained model for recognition of handwritten characters. Thus, according to the present embodiment, it is possible to suitably select a trained model to be used for handwritten character recognition from a plurality of trained models.

### Fourth Embodiment

Hereinafter, a fourth embodiment of the present disclosure will be described. In the present embodiment, a form will be described in which identification information of a user is obtained from a sheet to be read, and a trained model linked with the obtained identification information is selected from a plurality of trained models and used for recognition of handwritten characters.

### I/O Example

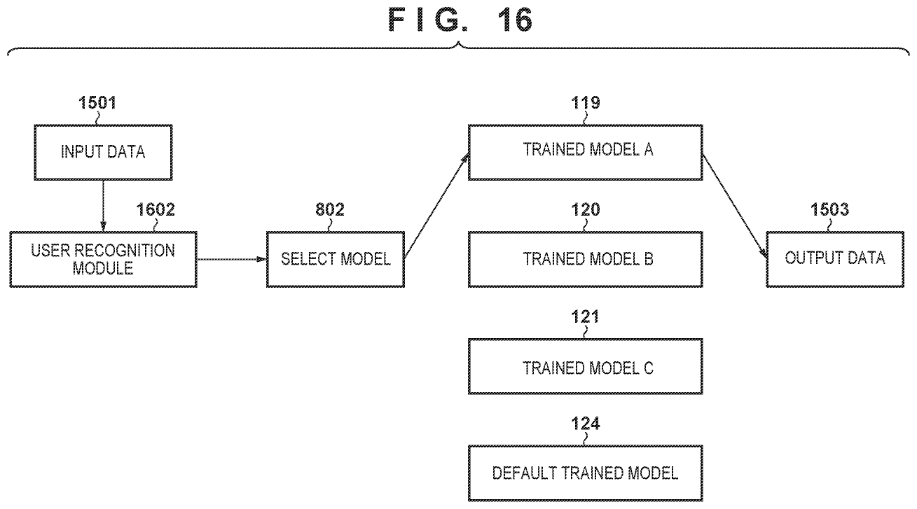

First, an example of input data and output data according to the present embodiment will be described with reference to FIG. 15. Here, an example in which the logged-in user name is recorded on the sheet to be read will be described, but the present disclosure is not intended to be limited thereto, and other identification information may be recorded, or the identification information may be of another user rather than the logged-in user.

Input data 1501 is obtained by converting into data an image obtained by using the reading unit 115 of the image processing apparatus 100 to read characters handwritten by a user on a sheet. A user name of the logged-in user or the like is written into a user designation region 1502 which is a designated region in the input data 1501. A user recognition module 1602, which will be described later, recognizes the user name (user identification information) written in the user designation region 1502, and notifies the model selection program 122 to use the trained model linked with the read user name. The model selection program 122 selects a trained model linked with a user name from a plurality of trained models. Here, although it is described that predetermined information is notified to the program, this means that the information is inputted as input data to a functional module realized by, for example, executing the model selection program 122. It is similar in the following description. Although an example in which the program is executed has been described here, the functional module may be implemented by hardware.

Output data 1503 indicates text data outputted from the selected trained models 119, 120, and 121 when the input data 1501 is inputted. In the present embodiment, the logged-in user name written in the user designation region 1502 is not converted into text in the output data 1503. That is, in the present embodiment, a recognition result for the handwritten characters written in regions other than the user designation region 1502 in the input data 1501 is outputted. Note that the present disclosure is not intended to be limited, and a recognition result for the user name written in the user designation region 1502 may be included in the output data.

### Inference Phase Data Flow

Next, a data flow in an inference phase according to the present embodiment will be described with reference to FIG. 16. In the inference phase according to the present embodiment, the input data 1501 is inputted to the user recognition module 1602 generated by executing a program in the storage 104.

When the input data 1501 is inputted to the user recognition module 1602, the user recognition module 1602 recognizes the logged-in user name written in the user designation region 1502 of the input data 1501, and notifies the model selection program 122 of the logged-in user name. By executing the model selection program 122, a trained model corresponding to the logged-in user name received from the user recognition module 1602 is selected. In the present embodiment, the trained model A 119 is selected, and the selected trained model A 119 inputs the input data 1501 and outputs the output data 1503.

### Processing Procedure

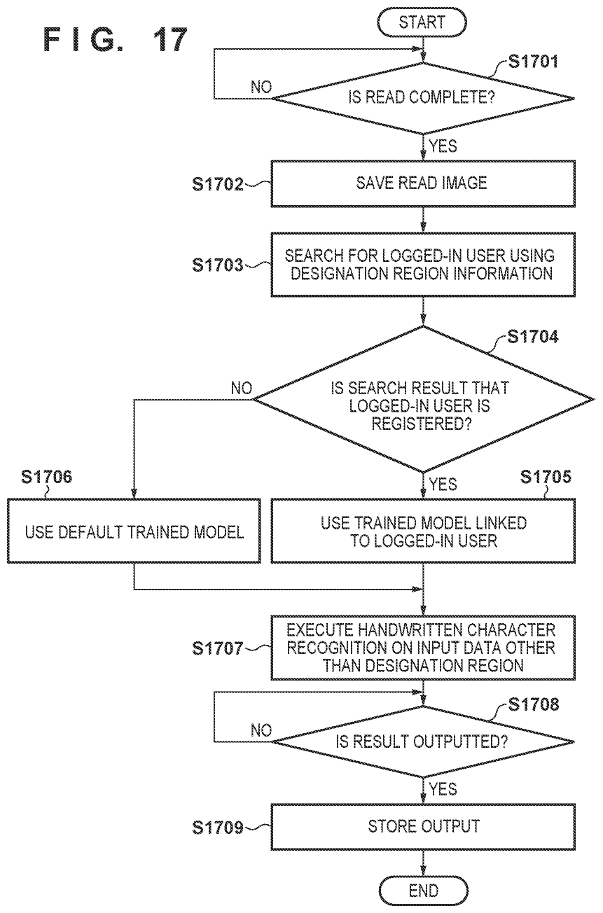

Next, a processing procedure of the image processing apparatus 100 that links a language setting and a trained model according to the present embodiment will be described with reference to FIG. 17. The process described below is realized by, for example, the CPU 101 reading a program (for example, the model selection program 122) stored in advance in the storage 104 into the RAM 103 and executing the program.

In step S1701, the CPU 101 determines whether or not the reading unit 115 has read a sheet on which handwritten characters have been written. When a read is completed, the CPU 101 proceeds to step S1702 and saves the input data 1501, which is the read-out image, into the storage 104. Subsequently, in step S1703, the CPU 101 performs optical character recognition on the user designation region 1502 part of the read image. Further, the CPU 101 identifies the logged-in user from the character recognition result in the user designation region 1502, and searches whether a trained model linked with the logged-in user is registered.

Next, in step S1704, the CPU 101 proceeds to step S1705 when a result of the search is that a trained model linked with the logged-in user is registered, and proceeds to step S1706 when such a trained model is not registered. In step S1706, the CPU 101 makes a setting to use the default trained model. Meanwhile, in step S1705, the CPU 101 makes a setting to use a trained model linked to the logged-in user.

Next, in step S1707, the CPU 101 performs handwritten character recognition using the trained model selected in step S1705 or step S1706 using data obtained by removing the user designation region 1502 from the input data 1501 as an input, and proceeds to step S1708. The processes of step S1708 and step S1709 are similar to the processes of step S1009 to step S1010 of FIG. 10, and description thereof will be omitted.

As described above, the image processing apparatus according to the present embodiment obtains identification information of a user from a sheet to be read, selects a trained model linked with the obtained identification information from a plurality of trained models, and uses the trained model for recognition of handwritten characters. Thus, according to the present embodiment, it is possible to suitably select a trained model to be used for handwritten character recognition from a plurality of trained models.

### Fifth Embodiment

Hereinafter, a fifth embodiment of the present disclosure will be described. In the present embodiment, a form will be described in which a feature of a handwritten character that is the target of character recognition is extracted, and a trained model linked with the extracted feature is selected from a plurality of trained models and used for recognition of handwritten characters.

### Inference Phase Data Flow

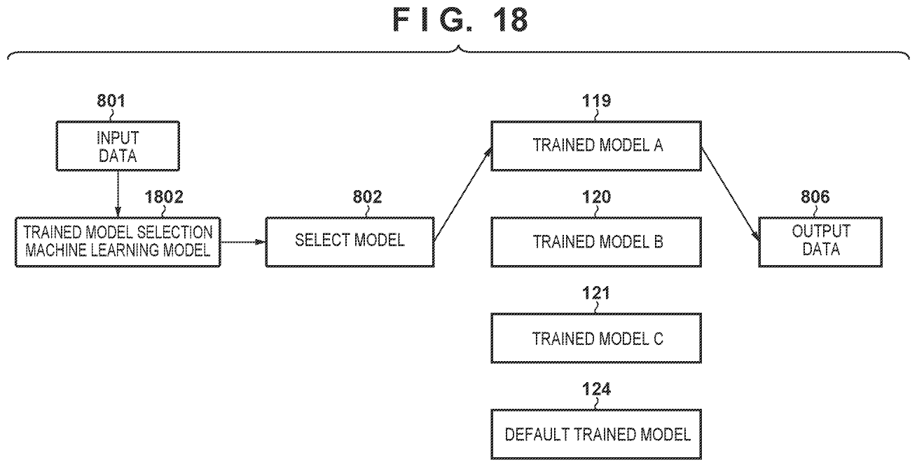

First, a data flow in an inference phase according to the present embodiment will be described with reference to FIG. 18. In the present embodiment, an appropriate trained model is automatically selected based on a feature extracted from the read handwritten characters.

When the input data 801 is inputted to a machine learning model 1802 for selecting a trained model, the machine learning model 1802 reads a feature of a handwritten character written in the input data 801, and searches whether a user linked with that feature is registered. Here, as a method of extracting a feature of a handwritten character, a known extraction method is used, and for example, a size of a character, a center of gravity, an inclination, an aspect ratio, and the like may be extracted as a feature amount. Using an extracted parameter of the feature amount, the similarity can be obtained by comparing the feature amount with feature amounts of users who have already been registered, and a user with a high degree of similarity can be decided as the corresponding user. If the user corresponding to the feature is registered as a result of the search, the module that executed the model selection program 122 is notified of the user.

The module that executed the model selection program 122 selects a trained model corresponding to the user received from the machine learning model 1802 from a plurality of trained models. In the present embodiment, the trained model A 119 is selected, and the selected trained model A 119 receives the input data 801 and outputs the output data 806.

### Processing Procedure

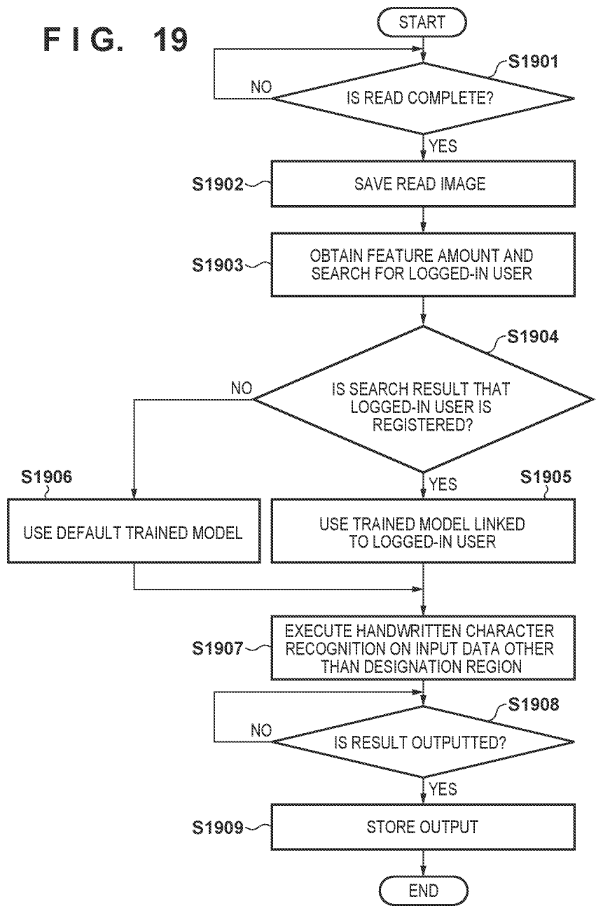

Next, a processing procedure of the image processing apparatus 100 that links an extracted feature and a trained model according to the present embodiment will be described with reference to FIG. 19. The process described below is realized by, for example, the CPU 101 reading a program (for example, the model selection program 122) stored in advance in the storage 104 into the RAM 103 and executing the program.

In step S1901, the CPU 101 determines whether or not the reading unit 115 has read a sheet on which handwritten characters have been written. When a read is completed, the CPU 101 proceeds to step S1902 and saves input data 1801, which is the read-out image, into the storage 104. Subsequently, in step S1903, the CPU 101 inputs the input data 801 into the machine learning model 1802 for selecting the trained model, obtains a feature amount of the handwritten characters, and searches for a similar feature amount of an already registered user. For example, if a user for which the degree of similarity is equal to or greater than a predetermined value is registered, the user is determined to be the user who wrote the handwritten characters. On the other hand, if only users for whom the degree of similarity is less than the predetermined value are registered, it is determined that no user with a similar feature is registered. If a user with a similar feature is registered as a result of the search in step S1904, the processing proceeds to step S1905, and if not, the processing proceeds to step S1906.

In step S1906, the CPU 101 makes a setting to use the default trained model, and the processing proceeds to step S1907. Meanwhile, in step S1905, the CPU 101 makes a setting to use a trained model linked to a registered user, and the processing proceeds to step S1907. Next, in step S1907, the CPU 101 inputs the input data 801 to the trained model selected in step S1905 or step S1906 to perform handwritten character recognition. Subsequently, in step S1908, the CPU 101 waits until a handwritten character recognition result is outputted by the trained model. When a result is outputted, the CPU 101 proceeds to step S1909, stores the outputted output data 806 in the storage 104, and ends the processing of this flowchart.

As described above, the image processing apparatus according to the present embodiment extracts a feature of a handwritten character that is a target of character recognition, selects a trained model linked with the extracted feature from a plurality of trained models, and uses the trained model for recognition of handwritten characters. Thus, according to the present embodiment, it is possible to suitably select a trained model to be used for handwritten character recognition from a plurality of trained models. In the above described embodiments, an example has been described in which the image processing apparatus 100 which includes the reading unit 115 reads an image of a document and performs character recognition. However, the present disclosure is not limited thereto, and a server capable of communicating with the image processing apparatus 100 may receive image data generated by the image processing apparatus 100 reading a document and performing character recognition on the received image data. At that time, a trained model may be selected from a plurality of trained models by a method of the above-described embodiments, and character recognition processing may be executed using the selected trained model. At this time, the screens of FIG. 6A, FIG. 6B, FIG. 11, and FIG. 13 may be displayed on the display unit of the server, and the setting may be performed using the operation unit of the server. The server may be the same as or different from the training server 200.

Further, in the above embodiment, an example has been described in which a trained model corresponding to a feature having a high degree of similarity with an extracted feature amount is selected from a plurality of trained models. However, the present disclosure can be variously modified, and a degree of similarity extracted for each trained model may be displayed on a selection screen or the like to provide information to the user, and a trained model selected based on a subsequent user operation may be used for handwritten character recognition.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-126608, filed Aug. 8, 2022, which is hereby incorporated by reference herein in its entirety.

What is claimed is:

1. An image processing apparatus comprising:
at least one memory device that stores a set of instructions; and
at least one processor that executes the set of instructions to obtain image data generated by reading a sheet on which a handwritten character is written;
select a trained model to be used for character recognition of the handwritten character on the sheet from a plurality of trained models; and
execute character recognition by using the selected trained model.

2. The image processing apparatus according to claim 1, wherein the at least one processor further executes the set of instructions to:
obtain the plurality of trained models linked to different users which are generated by training using image data of handwritten characters of the respective user and corresponding ground truth data.

3. The image processing apparatus according to claim 2, wherein the at least one processor further executes the set of instructions to:
set a link between a logged-in user of the image processing apparatus and the obtained plurality of trained models, and
select a trained model linked to the logged-in user of the image processing apparatus from the plurality of trained models.

4. The image processing apparatus according to claim 2, wherein the at least one processor further executes the set of instructions to:
set the trained model to be used for character recognition of handwritten characters of the sheet, based on a user operation, and
select the set trained model from the plurality of trained models.

5. The image processing apparatus according to claim 2, wherein the at least one processor further executes the set of instructions to:
set a link between a designated display language and the obtained plurality of trained models, and
select a trained model linked to the designated display language from the plurality of trained models.

6. The image processing apparatus according to claim 2, wherein the at least one processor further executes the set of instructions to:
recognize a user based user identification information read from a predetermined region of the sheet, and
select a trained model linked to the recognized user from the plurality of trained models, based on the recognized user.

7. The image processing apparatus according to claim 2, wherein the at least one processor further executes the set of instructions to:
extract a feature of a handwritten character written on the sheet, and based on the extracted feature of the handwritten character, select from the plurality of trained models a trained model trained in correspondence with a feature determined to be similar to the feature.

8. The image processing apparatus according to claim 7, wherein the at least one processor further executes the set of instructions to:
extract a feature of a handwritten character written on a sheet using a trained model, and based on the extracted feature of the handwritten character, select from the plurality of trained models a trained model trained in correspondence with a feature determined to be similar to the feature.

9. The image processing apparatus according to claim 2, wherein the at least one processor further executes the set of instructions to:
obtain the plurality of trained models from an external device capable of communicating with the image processing apparatus or an external storage capable of connecting with the image processing apparatus.

10. The image processing apparatus according to claim 1, wherein the at least one processor further executes the set of instructions to:
obtain image data from the sheet by using a reading unit that the image processing apparatus is provided with.

11. The image processing apparatus according to claim 1, wherein the at least one processor further executes the set of instructions to:
obtains image data read from the sheet by an external device.

12. A method of controlling an image processing apparatus, the method comprising:
obtaining image data generated by reading a sheet on which a handwritten character is written;
selecting a trained model to be used for character recognition of the handwritten character on the sheet from a plurality of trained models; and
executing character recognition by using the selected trained model.

13. A non-transitory computer-readable storage medium storing program for causing a computer to execute each step of a method for controlling an image processing apparatus, the method comprising:
obtaining image data generated by reading a sheet on which a handwritten character is written;
selecting a trained model to be used for character recognition of the handwritten character on the sheet from a plurality of trained models; and
executing character recognition by using the selected trained model.
